(19) United States
(12) Patent Application Publication
(10) Pub. No.: US 2011/0134385 A1
(43) Pub. Date: Jun. 9, 2011

(54) METHOD FOR REWORKING ADHESIVELY BONDED LIQUID CRYSTAL DISPLAYS

(76) Inventor: Hassan Mohamed Farah, Diamond Bar, CA (US)

(21) Appl. No.: 12/810,185

(22) PCT Filed: Dec. 22, 2008
(86) PCT No.: PCT/US2008/087959

§ 371 Date: Jul. 26, 2010

Related U.S. Application Data
(60) Provisional application No. 61/009,430, filed on Dec. 28, 2007.

(51) Int. Cl. G02F 1/13

(52) U.S. Cl. 349/187

(57) ABSTRACT

A method is disclosed for reworking a bonded LCD having a substrate (e.g., plate or film) adhesively bonded to a face (e.g., front face) of the LCD. The method provides for efficient and clean removal of the substrate from the LCD when necessary (e.g., when defect(s) are present) without damage to the LCD such that the LCD can subsequently be re-bonded.

### CROSS REFERENCE TO RELATED APPLICATION

This patent application claims the benefit of U.S. Provisional Patent Application Ser. No. 61/009,430 filed on 28 Dec. 2007

### FIELD OF THE INVENTION

The invention is directed to a method for reworking an adhesively bonded liquid crystal display (LCD).

### BACKGROUND OF THE INVENTION

In today's market, flat panel displays, such as liquid crystal displays (LCD), are often enhanced with specialized films. The films may be flexible or rigid. Such films are designed to optimize optical performance, e.g., viewing contrast, increasing brightness, removing glare, enhancing color and enhancing the clarity of the flat panel display or improve display functionality, such as bonding a touch panel to the front surface. The films are typically applied to the viewing side of the display. Application methods involve the use of an adhesive that is optically clear and pressure sensitive for easy bonding directly to the display.

Curable adhesives (e.g., heat or light cured) have been used in applications where substrates require substantial permanency and high strength adherence. Conventional adhesives (e.g., tape, silicone), however, are typically not easy to apply, or provide the benefits of curable adhesives. An adhesive material for application of a film to a base material is described in U.S. Pat. No. 6,139,953. For optical product applications, curable adhesives have been desirable, as they can provide optically clear, strongly adhered laminates (e.g., layered substrates).

To achieve both strength and ease of application, hybrid compositions have been developed that can be used in optical applications. For example, a light curable, polyester based adhesive has been used for plastic glazing applications. In digital video disc (DVD or optical discs) bonding and cathode ray tube (CRT) applications, a liquid adhesive formulation has been used. For bead bonding in making retroreflective articles, a curable polymeric network has been suggested.

Strength and application, however, are not the only criteria that many optical substrates/laminates require. Certain optical products are exposed to harsh environmental conditions, such as heat, UV (solar) light, water, etc. For example, vehicle windshields generally exist in outdoor conditions that submit them to all types of weather. These windshields typically include substrates such as acrylic or polycarbonate, adhered to a solar or infra-red (IR) reflecting film made from a multi-layer optical film (MLOF) (3M Co., St. Paul, Minn.). The materials may become optically obstructed if the adhesion between the layers is damaged or compromised.

Light curable liquid acrylic ester adhesives for glass bonding using low intensity ultraviolet (“UV”) light are known. Such adhesives are useful for glass assembly and repair applications in which high intensity UV light is unavailable or impractical.

A number of fast curing low-yellowing acrylate functional oligomer products are known for use in UV/electron beam (“EB”) curable printing inks and the like. However, such products typically have poor adhesive strength to glass.

It is desirable and often necessary for a viable commercial UV/visible curable adhesive suitable for glass bonding to possess several key properties—e.g., having good adhesive strength, fast tact time, optical clarity and reduced yellowing. An additional key property that is highly desirable in an optical adhesive (in the cured state) targeted for use in display applications is reworkability. With regard to reworkability, one or more events can occur during manufacture, shipping, and/or in use that requires the film and adhesive to be removed easily and cleanly from the display and replaced. Some examples of such events are 1) defects in bonding during application of the specialized film to the display may necessitate on-site repair, 2) damage to a LCD occurring during its use, and 3) a component (e.g., LCD, glass, touch panel) of a device becoming defective after placement in the device. Present commercially-available adhesives and associated methods fall short with regard to reworkability and with regard to one or more of the above-mentioned other key properties. The present invention offers a solution towards reworkability in providing an efficient rework method that is cost-effective, semi-automated, safe, and reliable.

### SUMMARY OF THE INVENTION

In an embodiment, the invention is a method for reworking a liquid crystal display having a surface and a substrate adhesively bonded with a cured adhesive layer to the surface of the display, the method comprising:

a) slicing through the cured adhesive layer with a tool such that the substrate is no longer bonded to the liquid crystal display; and

b) removing the cured adhesive layer from the liquid crystal display to afford a de-bonded liquid crystal display.

### GLOSSARY OF TERMS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. The materials, methods, and examples described herein are illustrative only and not intended to be limiting.

### DETAILED DESCRIPTION OF THE INVENTION

In an embodiment, the invention is a method for reworking a liquid crystal display having a surface and a substrate adhesively bonded with a cured adhesive layer to the surface of the display, the method comprising:

a) slicing through the cured adhesive layer with a tool such that the substrate is no longer bonded to the liquid crystal display; and

b) removing the cured adhesive layer from the liquid crystal display to afford a de-bonded liquid crystal display.

As used herein, the term “slicing” can mean, but is not limited to, equivalent or related terms like “cutting”, “shearing”, and “sawing”.

In an embodiment, the tool can be a wire in a U-shaped loop that is drawn through the cured adhesive layer starting at one edge of the cured adhesive layer and ending at an opposing edge of the one edge of the cured adhesive layer.

In one mode or aspect of the immediately preceding embodiment, the wire is repetitively advanced in at least one cycle through the cured adhesive in an incremental, cyclic fashion with the at least one cycle corresponding to one end of the wire first being incrementally advanced with respect to that of the other end of the wire and then the other end of the wire being incrementally advanced with respect to that of the one end of the wire.

In an embodiment, the tool can be a knife that is drawn through the cured adhesive layer starting at one edge of the cured adhesive layer and ending at an opposing edge of the one edge of the cured adhesive layer.

In an embodiment, the liquid crystal display is heated at an elevated temperature prior to its being subjected to step a) of the above method.

In an embodiment, the tool is heated at an elevated temperature prior to its use in step a).

In an embodiment, the tool is heated at an elevated temperature during its use in step a).

In an embodiment, the method further comprises:

c) cleaning the de-bonded liquid crystal display to remove any residual cured adhesive to afford a liquid crystal display that is ready for reworking.

### DEFINITIONS

Reworkability—Reworkability of an adhesively-bonded display (e.g., LCD) in this invention is defined to mean that the cured bonded adhesive when desired or necessary can, without undue difficulty or long time requirement(s), be cleanly and effectively removed during disassembly of the display to remove a substrate (e.g., film or glass plate or touch panel) from being bonded to the display by the cured adhesive layer. An example where reworkability is desired and needed is when an air bubble or other defect is found in a bonded display. Other examples where reworkability is desired include cases where a component in a display becomes defective or there is damage to part of a display in use. In one or more of these events, it is highly desirable that the substrate and adhesive be removed from the display such that the bonding process can afterwards be repeated hopefully to afford a bonded display without the flaw, damage, or defect being present subsequent to reworking. If reworking is not feasible, then the defective bonded display cannot typically be corrected and is usually then discarded, which corresponds to a relatively high value loss of the display as well as the film or plate.

More specifically, a cured adhesive (bonding a substrate to an LCD) that is reworkable is one that is compatible with a thread, a wire or other rework tool to be drawn/sliced/cut through it and thereby afford a basically clean separation of the substrate from the LCD. Typically after this drawing/slicing/cutting step, both the adhesive side of the LCD and the adhesive side of the substrate will have some residual adhesive on these two sides. Furthermore, subsequent to this step, a good adhesive that is reworkable is one that provides a clean separation of adhesive from the substrate, the LCD, and/or other parts being bonded with the adhesive.

### EXAMPLE

### Adhesive Sample

An adhesive sample was prepared having the following composition:

| Component | Weight Percent |
|---|---|
| Aliphatic Urethane Acrylate | 47.5 |
| (Sartomer CN9002, Sartomer Co., Exton, PA) | |
| Cyclic Trimethylolpropoane formal acrylate | 14.5 |
| (Sartomer SR531, Sartomer Co., Exton, PA) | |
| Dibutoxyethoxyethyl adipate | 30 |
| (Sartomer Wareflex SR650) | |
| Pentaerythritol tetrakis(3-mercaptoproprionate) | 7 |
| 2,4,6-Trimethylbenzoydilphenylphosphine oxide | 0.5 |
| (Esacure TPO, Sartomer Co., Exton, PA) | |
| Difunctional alpha-hydroxy ketone | 0.5 |
| (Esacure ONE, Sartomer Co., Exton, PA) | |

### Bonding Preparation Using LCD Fixture

An LCD fixture was prepared for bonding an LCD to a glass plate using the above photocurable adhesive composition and also using a dam technique in a laboratory method which confines uncured liquid adhesive only in areas of the LCD where bonding is desired. A NEC NL10276BC24-13 LCD panel was used in this example, which panel was obtained from NEC Electronics America, Inc., Dallas, Tex. The dam used was a raised tape edging together with shims to define the thickness level of cured adhesive. The adhesive was poured into the “dammed” area of the LCD fixture. The glass was then placed onto the adhesive with the adhesive spread out so there were no visible air bubbles. This fixture was then UV light cured using a Fuson UV “D” bulb at an intensity level and exposure time to give adequate curing as is well known to those skilled in the art of photocurable adhesives. This curing afforded a photocured adhesive layer between the glass and the front polarizer of the LCD.

### Reworkability Testing and Results

A glass plate was bonded to a NEC LCD panel as detailed above. To test reworkability, the resulting bonded LCD panel was heated and then a heated wire was used to “slice through” the cured adhesive layer of this bonded LCD panel and to thereby initiate separation of the glass plate from the LCD at the adhesive interface. The wire was held at both ends by a technician such that it had a U-shape as it was drawn through the cured adhesive layer to effect de-bonding. The U-shaped wire was drawn through the cured adhesive layer with a sawing-type of incremental movement. More specifically, this movement entailed incrementally advancing the wire more first on one side (right or left, with respect to the operator) and then incrementally advancing the wire more on the other side (right or left). This incremental advancing of the wire as it sliced through the adhesive was repeated a number of times on both right and left sides as was necessary to slice through the cured adhesive from one side to the opposing side. The time required to draw the wire through the adhesive layer to thereby de-bond the glass plate from the LCD and subsequently remove clumps of adhesive material from the LCD and glass plate was measured. The NEC LCD having a glass plate bonded to it using the above adhesive composition was successfully de-bonded within 20 seconds to afford essentially the original LCD that was undamaged and which could now be used for re-bonding the same or another glass plate to this LCD to afford a bonded glass plate/LCD.

What is claimed is:

1. A method for reworking a liquid crystal display having a surface and a substrate adhesively bonded with a cured adhesive layer to the surface of the display, the method comprising:
a) slicing through the cured adhesive layer with a tool such that the substrate is no longer bonded to the liquid crystal display; and
b) removing the cured adhesive layer from the liquid crystal display to afford a de-bonded liquid crystal display.

2. The method of claim 1 wherein the tool is a wire in a U-shaped loop that is drawn through the cured adhesive layer starting at one edge of the cured adhesive layer and ending at an opposing edge of the one edge of the cured adhesive layer.

3. The method of claim 2 wherein the wire is repetitively advanced in at least one cycle through the cured adhesive in an incremental, cyclic fashion with the at least one cycle corresponding to one end of the wire first being incrementally advanced with respect to that of the other end of the wire and then the other end of the wire being incrementally advanced with respect to that of the one end of the wire.

4. The method of claim 1 wherein the liquid crystal display is heated at a temperature above ambient temperature prior to its being subjected to step a).

5. The method of claim 1 wherein the tool is heated at a temperature above ambient temperature prior to its use in step a).

6. The method of claim 1 wherein the tool is heated at a temperature above ambient temperature during its use in step a).

7. The method of claim 1 further comprising:
c) cleaning the de-bonded liquid crystal display to remove any residual cured adhesive to afford a liquid crystal display that is ready for reworking.
